(19) United States
(12) Patent Application Publication
(10) Pub. No.: US 2026/0241918 A1
(43) Pub. Date: Aug. 20, 2026

(54) Method and Assistance System for a Relevance Assessment of Objects in the Environment of a Motor Vehicle

(71) Applicant: Bayerische Motoren Werke Aktiengesellschaft, Muenchen (DE)

(72) Inventors: Christian LENK, Muenchen (DE); Daniel MEISSNER, Friedberg (DE); Alexandros THEODORIDIS, Muenchen (DE)

(21) Appl. No.: 18/870,910

(22) PCT Filed: Jun. 16, 2023
(86) PCT No.: PCT/EP2023/066262

§ 371 Date: Dec. 2, 2024

(30) Foreign Application Priority Data
Jun. 23, 2022 (DE) 10 2022 115 620.6

(51) Int. Cl. B60W 30/02; B60W 30/16; B60W 40/02; B60W 50/00

(52) U.S. Cl. CPC B60W 30/025; B60W 30/16; B60W 40/02; B60W 50/0098; B60W 2554/802; B60W 2754/30

(57) ABSTRACT

The present disclosure relates to a method and an assistance system for a relevance assessment of objects in an environment. The present disclosure also relates to a correspondingly configured motor vehicle. In a method, based on environment data, the individual relative movements of the objects relative to the motor vehicle are determined. On this basis, according to driving parameters specified for the motor vehicle, a respective distance is determined for each detected object, which is required behind the respective object to achieve a stable status. On this basis, a respective relevance check is carried out for the detected object, wherein the respective object is classified as relevant or not relevant for the controlling of the motor vehicle.

### BACKGROUND AND SUMMARY

The present invention relates to a method and an assistance system for a relevance assessment of objects in a respective environment of a correspondingly equipped motor vehicle. The invention further relates to such a motor vehicle.

In today's motor vehicles, there are many different assistance functions and systems to support the driver in driving the vehicle or to at least partially automate the driving of the vehicle. These functions and systems typically rely on environment recognition, i.e., the most accurate possible recognition of objects in the respective environment. This applies, for example, to longitudinal control functions such as adaptive cruise control (ACC). However, not only must objects be recognized, but ideally it must also be determined whether or not a particular object is relevant for the guidance of the vehicle or the control of a corresponding assistance function or vehicle equipment.

Nowadays, there are also increasing demands on the quality and functionality of corresponding assistance functions and systems, as well as on driving and occupant comfort. Accordingly, objects should, for example, be detected as early as possible and, if necessary, classified as relevant in order to avoid abrupt maneuvers, while at the same time improving the quality or reliability with regard to avoiding false detections or misclassifications and correspondingly incorrect or unnecessary reactions. In principle, one approach to achieve this could be to increase the relevance range within which objects are classified as relevant. However, this can have disadvantages, such as limited performance, i.e., accuracy and reliability, particularly in urban areas, on winding country roads and generally in relatively complex traffic situations, as well as limited scalability for new functions, particularly at automation level 2 and higher. A corresponding expansion of the field of application or use, i.e., the so-called ODD (Operational Design Domain), is often hindered by an increased false positive rate at greater distances and an increased false negative rate at close range. There is therefore still a need for improvements.

As one approach, DE 102009 006 747 A1 describes an environment assessment system for assessing objects in the environment of a vehicle with regard to the relevance of the objects as target objects for a warning control system of the vehicle. In a first step, each detected object is evaluated with regard to its lateral relevance and, separately, with regard to its longitudinal relevance for the vehicle itself. In a second step, an overall relevance is calculated for each detected object from its lateral relevance and its longitudinal relevance. In a third step, the detected object with the maximum overall relevance is selected as the only target object for the vehicle. In this way, a predictive and unambiguous selection of a target object can also be ensured from several detected objects.

For the implementation of assistance functions or systems, a driving tunnel, which is also referred to as a driving corridor, of the respective motor vehicle is often considered. To this end, DE 102013 015 028 A1 discloses a method for operating a vehicle, wherein a driving tunnel, within which the vehicle will move with a high probability, is predicted and a vehicle environment is detected. In the process, the driving tunnel is predicted in such a way that it tapers in the direction of travel with increasing spatial and/or temporal distance from an instantaneous vehicle position. The relevance of an object detected in the vehicle environment ahead is then determined as a function of the position that the object currently occupies relative to the line or is likely to occupy in the near future. Depending on the determined relevance of the object for the vehicle, a decision is then made as to whether an automatic initiation of a collision avoidance or collision impact mitigation measure should be permitted.

DE 102013200409 A1 also deals with monitoring the environment of a vehicle. The method there comprises reading in a distance image with respect to the environment, wherein the distance image comprises a plurality of distance values. These distance values represent a result of a plurality of distance measurements carried out using a sensor for stereo image detection with respect to the vehicle's environment detected by the sensor. Furthermore, the method comprises recognizing an obstacle located in the environment using distance values contained in a selected section of the distance image. Furthermore, a number and quality of relevant distance values are determined, which represent distance values contained in the section that can be assigned to the obstacle. Lastly, a value of an existence measure for the existence of the obstacle is determined based on the number and quality of the relevant distance values.

One object of the present invention is to enable improved detection of objects relevant for vehicle guidance.

According to implementations of the invention, this object is achieved by the subjects of the independent claims. Possible embodiments and developments of the present invention are disclosed in the dependent claims, in the description and in the FIGURE.

The method according to the invention can be used to assess the relevance of objects in an environment of a motor vehicle. In a method step of some forms of a method according to the invention, environment data are recorded which indicate or characterize objects located in a respective environment of the motor vehicle. In particular, the environment data can be recorded or have been recorded by means of an environment sensor system of the respective motor vehicle. The environment data can also originate, for example, from other road users and/or a traffic monitoring infrastructure or the like and then be or have been recorded via a Car2X, WLAN or mobile radio data connection or the like. In the present sense, recording this environment data can mean or include receiving or retrieving it via a corresponding interface or from a data memory or also recording it by means of a corresponding environment sensor system.

In the present sense, the objects may in particular be or include other road users, such as other vehicles, which may also be referred to as third-party vehicles.

The environment in which these objects are located or in which these objects are or were detected can, in particular, be an area in front of the vehicle in its direction of travel.

In a further method step of some forms of a method according to the invention, the individual relative movements, in particular the relative velocities or also the relative accelerations, of the objects relative to the motor vehicle are determined. For this purpose, depending on the type of environment data, corresponding data or information can be extracted or calculated from these, for example. The relative movements of the objects can therefore be determined individually. The current positions of the objects can also be determined, for example relative to the vehicle or in a predefined coordinate system, particularly one that is fixed to the world. Likewise, the position and the inherent movement, i.e., in particular the speed and direction of movement or even the acceleration, of the motor vehicle, for example in relation to the specified coordinate system, can be determined or retrieved, for example via an on-board network or from a corresponding control unit or sensor of the motor vehicle or similar.

In a further method step of some forms of a method according to the invention, a respective, i.e., object-specific distance is determined, i.e., calculated, for each detected object, taking into account, i.e., depending on, driving parameters specified for the motor vehicle, which would be required to reach a stable state of the motor vehicle behind the respective object. This distance can therefore be required if the respective object is assumed to be the object in front or the motor vehicle is driving behind this object or is positioned behind this object. The distance determined here can in particular be a spatial distance, i.e., a route. The distance can also be a temporal distance, i.e., a time or duration. These two possibilities can be regarded as effectively equivalent here, as the distance and the corresponding time are firmly linked to each other via the speed of the vehicle and the driving parameters or specified safety criteria and can therefore be converted into each other. For example, a time required to reach the stable state could first be determined and then converted into the corresponding spatial distance, which can then be used for one or more further data processing steps. The distance determined here can, for example, be a minimum distance, i.e., a distance that is at least expected to be required to reach the stable state, taking into account the specified driving parameters or the specified safety criteria. The specified distance can also be, for example, a minimum time, i.e., a time or duration that is at least expected to be required to reach the stable state, taking into account the specified driving parameters or the specified safety criteria. For example, a constant movement of the respective object can be assumed or, for example, an expected or probable movement of the respective object can be simulated using a corresponding predetermined movement model or similar.

The other distances, ranges and/or areas mentioned here can also be understood as spatial variables or as corresponding temporal variables.

The predefined parameters can, for example, specify intervals, average values, values to be expected in the respective situation and/or limit values for one or more variables influencing or limiting the movement of the motor vehicle. The predefined parameters can be used to specify or take into account which movement or change in movement of the motor vehicle is technically possible, safe, comfortable or desired. The predefined parameters can, for example, specify a maximum jerk, a maximum acceleration, a maximum deceleration, a maximum yaw rate, a target or target speed, a safe distance or a desired distance to the respective object and/or the like. A set or target speed can be, for example, a locally permissible maximum or minimum speed, a desired speed set by a driver of the motor vehicle for a cruise control system of the motor vehicle, a speed determined or targeted by a system for longitudinal guidance of the motor vehicle in the respective situation or the like.

A stable state can be achieved, for example, if a distance between the motor vehicle and the respective object does not decrease any further, i.e., remains the same or increases, the motor vehicle has the same speed as the respective object or a lower speed than the object, in particular with a given safety or minimum distance or specified desired distance to the respective object, no active control interventions in the longitudinal guidance of the motor vehicle are necessary in order to avoid a collision between the motor vehicle and the respective object, or similar. In other words, a stable state in the present sense can therefore be given if the motor vehicle can safely maintain its then specified state of motion.

The aforementioned at least one object-specific distance can be calculated as the spatial distance s, for example, as the sum of a specified distance offset as the first summand, the product of a specified time constant and the respective setpoint or target speed as the second summand and the distance required for any braking maneuver to be performed to reach the stable state as the third summand. This can be expressed, for example, by the following relationship:

$$s = a + b \cdot MIN ( {V}_{ego} , {V}_{target} ) + C \cdot {V}_{rel}^{2} ,$$

wherein a, b, c are predefined parameters, v_{ego} is the speed of the motor vehicle, v_{target} is the speed of the respective object, MIN is the minimum of these and vᵣₑₗ is the relative speed of the motor vehicle and the respective object, where MIN (v_{ego}, v_{target}) can represent the target speed. Primarily, the middle term corresponds to the above-mentioned time required to reach the stable state behind the respective object. The first term can be understood as the distance offset. The last term corresponds to the distance required for braking to reach the stable state. Depending on the specified parameterization, i.e., specified values of the parameters a, b, c, different distances can be calculated. The distance can, for example, include or take into account the movement of the motor vehicle in the respective time or also a specified minimum or safety distance or a desired distance to the respective object set by a driver of the motor vehicle. For example, the distance can therefore take into account or include the distance expected to be covered by the motor vehicle in the respective time. However, the speed at which the respective object may be moving and the resulting additional space available for maneuvers of the motor vehicle can also be taken into account. The at least one distance can be calculated under one or more predetermined assumptions or boundary conditions, which determine the ODD for the method according to the invention or an assistance system based thereon. For example, it may be provided that the method according to the invention is only used as described if the respective object is not actively moving towards the motor vehicle, the motor vehicle is not in a fully manual operating mode or the like. It can also be assumed, for example, that the motor vehicle is not actively accelerating towards the respective object. Likewise, the corresponding object-specific time or—for example with correspondingly different parameterizations-several object-specific times can be determined first. These can then be converted into the described spatial distance or distances.

In a further method step of the method according to the invention, a relevance check is carried out for the detected objects on the basis of the respective at least one object-specific distance, wherein the respective object is classified as relevant or not relevant for the guidance of the motor vehicle. For example, an object can be classified as relevant if its current distance to the motor vehicle is at most as great as the distance or a distance determined for this object. Otherwise, if the object is further away from the motor vehicle than the distance or a distance specified for this object, the object can be classified as not relevant. The distance can therefore be used as a threshold value for the relevance of the respective object or as a basis for determining or setting such a threshold value.

With the present invention, the actual relevant objects can be determined or tracked particularly easily, reliably and with little effort, even with a large number of detected objects. In comparison to previous approaches, the individual approach also allows objects that are particularly far away from the vehicle to be classified as relevant or not relevant without having to accept the problems of expanding the relevance range described above. In addition, due to the divisibility over time, the relevance description per object can be better adapted to an extended ODD or new functions or applications compared to conventional approaches. The present invention allows both increased quality and convenience requirements to be met, as explained in greater detail elsewhere.

In one possible embodiment of the present invention, a predetermined maximum possible or maximum permissible jerk of the motor vehicle is also taken into account when determining the respective distance. In the present sense, the jerk is the derivative or change in acceleration. This means that it is possible to take into account how quickly a current acceleration of the vehicle can be reduced. The maximum permissible jerk can, for example, be a predetermined maximum value or a maximum possible jerk technically or in compliance with predetermined safety criteria, taking into account or depending on current operating conditions and/or environmental conditions. The maximum possible or permissible jerk can also be set by a driver of the motor vehicle. By taking the jerk into account as proposed here, the respective distance can be determined particularly accurately or in detail. This can ultimately enable a particularly accurate and reliable relevance classification.

In a further possible embodiment of the present invention, the relevance is determined for all detected objects. A driving tunnel or driving corridor in which the motor vehicle is expected to move is also predicted or estimated. Only those of the detected objects that have been classified as relevant and are located in the driving tunnel are then output or marked as relevant objects, i.e., objects that may need to be taken into account for at least one predefined driving assistance function of the motor vehicle. This can apply, for example, at least to objects outside the driving tunnel for which no movement into the driving tunnel is predicted. Objects located inside the inner tunnel can be classified as relevant for the driving assistance function, i.e., as—at least potentially—to be taken into account by the driving assistance function. Such a driving assistance function can be, for example, adaptive cruise control (ACC) or the like. The embodiment of the present invention proposed here can, for example, reduce the computational effort for the driving assistance function for selecting a target or control object for the driving assistance function. The method according to the invention can then, for example, also support or enable an effective application of a corresponding assistance function by means of an embedded system, i.e., correspondingly limited hardware resources, reliably and robustly as well as with particularly low latency.

In a further possible embodiment of the present invention, the determination of the at least one distance comprises determining a first distance and a greater second distance for each of the detected objects. The first distance results as the minimum distance for safe driving of the motor vehicle, i.e., the minimum distance required to reach the stable state without collision. The first distance can, for example, be determined using the above formula with a predefined first parameterization. The second distance, which can also be referred to here as the maximum or comfort distance, on the other hand, results from a more comfortable vehicle control in comparison. In other words, a smaller jerk, a lower acceleration or deceleration, lower forces, a lower yaw rate and/or the like can be assumed or used as a basis for determining the second distance, for example. The second distance can, for example, be determined by means of the above formula using a predetermined second parameterization. In the embodiment of the present invention proposed here, the first distance, the second distance or a distance in between is then used for the relevance check. In other words, the first distance and the second distance define boundaries of a closed interval, i.e., including these boundaries, wherein the distance ultimately used for the relevance classification or relevance check, i.e., for example as the corresponding threshold value, is part of this interval. Which distance is actually used as the threshold value for relevance can be predetermined or determined dynamically, for example depending on the situation, use case or individual requirements or objectives for the respective application of the present invention. On the one hand, the embodiment of the present invention proposed here can ensure that objects whose distance from the motor vehicle is less than the first distance, i.e., for which there is a risk of collision, are always classified as relevant. On the other hand, the second distance can limit the number and distance of objects potentially classified as relevant. This can also limit the amount of data processing required. This is based on the realization that objects that are further away from the vehicle than the second distance can typically be disregarded for the guidance of the vehicle without sacrificing comfort or safety.

In a possible development of the present invention, the driving tunnel or driving corridor in which the motor vehicle is likely to move is predicted or estimated. Furthermore, a quality, for example a precision, certainty or confidence, of this estimate is then determined. Based on this, a third distance is also determined, which is or becomes smaller if the quality of the estimate of the driving tunnel is lower and larger if the quality of the estimate of the driving tunnel is higher. If this quality-based third distance is smaller than the first distance, an object is only classified as relevant if its distance from the vehicle corresponds at most to the first distance. In other words, the first distance is maintained as the minimum distance for the relevance check even if the quality of the estimation of the driving tunnel is very low or poor, which would lead to a third distance that is less than the first distance. This means that correspondingly close objects can be reliably classified as relevant, which can contribute to improved safety. If the quality-based third distance is greater than the second distance, an object is only classified as relevant if its distance from the vehicle is no greater than the second distance. In other words, the relevance range is also limited to the second distance if the estimation of the driving tunnel is particularly accurate and reliable or safe and it can therefore be known with a correspondingly high degree of confidence which objects are located in the driving tunnel of the motor vehicle, even at a distance greater than the second distance. As a result, the corresponding data processing effort, for example for tracking a correspondingly large number of objects, can be limited or reduced, wherein due to the correspondingly large distance of objects that are further away from the motor vehicle than the second distance and are therefore not classified as relevant, neither a significant loss of comfort nor a significant loss of safety must be accepted.

If the quality-based third distance lies between the first distance and the second distance, an object is only classified as relevant if its distance from the motor vehicle corresponds at most to the third distance. In other words, the quality-based third distance defines the relevance range. This means that the third distance is used as a threshold value in the relevance check if it lies within the interval formed, defined or limited by the first distance and the second distance. If, on the other hand, the quality-based third distance lies outside this interval, its nearest interval boundary, i.e., either the first distance or the second distance, is used as the threshold value in the relevance check. With the embodiment of the present invention proposed here, both particularly high quality and performance requirements and particularly high comfort requirements for assistance functions and systems for assisted or at least partially automated driving of the motor vehicle can be met.

The estimation of the driving tunnel can, for example, correspond to an estimation of the course of the road ahead in the direction of travel of the motor vehicle or take this course of the road into account. The third distance can therefore be introduced here as an additional distance, which is based on the quality of the estimation of the driving tunnel and thus on the quality of the available inputs characterizing or estimating the course of the road. Such inputs can be or include, for example, measurement or sensor data from a, in particular multimodal, environment sensor system of the motor vehicle, trajectories or movement or control data from third-party vehicles, map data and/or the like.

The quality of the estimate of the driving tunnel can, for example, take into account the uncertainties of these inputs, so that greater uncertainties lead to a lower quality. In the present sense, this quality can be understood as the quality of the prediction of the driving tunnel, i.e., the area that the vehicle will drive through. This quality can, for example, be particularly low and lead to a correspondingly low third distance if the driving tunnel is estimated solely on the basis of the current steering angle of the motor vehicle. In such a case, however, using the first distance as a threshold value for the relevance check can still ensure that objects detected that are correspondingly close, but possibly further away from the motor vehicle than the third distance, are classified as relevant so that they can be taken into account in a corresponding control or regulation system, for example. In order to determine the quality of the driving tunnel estimation, for example, the recognizability of a lane boundary, a resolution or a level of detail of a map, a localization accuracy of trajectories of other road users and/or the like can be used or taken into account. It can also be taken into account, for example, that the uncertainty of the corresponding measurements can increase or typically increases with increasing distance from the motor vehicle, that an error can have a greater effect at a greater distance, i.e., that a greater error effect can occur at a greater distance, and/or the like. Likewise, contradictions or covariances of different inputs that indicate a lower statistical correlation can lead to poorer quality or mean poor quality. The third distance can be determined individually for each object or by area or globally, i.e., equally valid for all objects. The latter can be realized with particularly low data processing effort, while the former options can enable a particularly robust relevance check, for example if different sections of the driving tunnel were estimated with different qualities or accuracies.

In a possible development of the present invention, the quality of the driving tunnel estimate is determined as a function of distance. The distance at which the quality falls below a predetermined quality threshold is then used as the third distance. In other words, the quality of the driving tunnel estimate can therefore decrease with increasing distance from the motor vehicle, i.e., with a correspondingly larger prediction horizon. The quality threshold can be specified in particular for a standard deviation of the quality, the estimation of the driving tunnel and/or the inputs used for this, i.e., data or measurements. The quality threshold value can also be specified, for example, for a convolution of the estimation of the driving tunnel with an uncertainty of the object detection. With the embodiment of the present invention proposed here, a particularly robust and reliable determination of the relevant objects can be achieved or made possible, in particular if the third distance lies between the first distance and the second distance.

In a further possible embodiment of the present invention, in the event that a stable state of the motor vehicle has already been reached with respect to a detected object, i.e., is given, the relevance range extended by the motor vehicle in the direction of this object, within which objects are classified as relevant, is limited to a predetermined standard distance or the current distance to the respective object. Such a standard distance can, for example, be fixed or dynamically specified, depending on the current speed of the vehicle, the nature of the local road surface or similar. The predefined standard distance can ensure that objects are always classified as relevant if they represent a collision risk or may require an emergency braking intervention or similar. The specified standard distance can also be a desired distance specified by the driver of the vehicle. A stable state with regard to an object can already be present when it is detected, for example, if the object is at least a predefined minimum distance from the motor vehicle and is moving at the same speed as the motor vehicle in the same direction of travel as the motor vehicle or is moving away from the motor vehicle. In such a state and in such a position, an object can be detected for the first time, for example, when in this state and in this position it enters a lane traveled by the motor vehicle or the like. With the embodiment of the present invention proposed here, the relevance range can be determined particularly simply and with little effort in such cases, which can enable a correspondingly simple and low-effort relevance check.

In a further possible embodiment of the present invention, objects classified as relevant are only classified as no longer relevant from a deselection or rejection distance that is greater than the distance up to which the objects would be classified as relevant. The rejection distance can be determined for each individual object. The rejection distance can therefore depend, for example, on the relative movement and/or relative position of the respective object in relation to the motor vehicle. In the same way, the rejection distance can, for example, be greater by a specified amount or percentage than the distance up to which the respective object was classified as relevant. A further parameterization of the above formula for the distance can also be predefined to determine the respective rejection distance. The fact that the rejection distance can always be greater than the greatest relevance distance up to which the respective object would be classified as relevant, i.e., the respective relevance range, means that an inconsistent, frequently and rapidly changing classification of an object can be avoided if it is located in the area of the greatest relevance distance, i.e., at the end of the relevance range furthest away from the motor vehicle. The behavior proposed here can therefore be understood as a kind of hysteresis, in which an object that is at the maximum distance from the motor vehicle, which would still lead to it being classified as relevant, must move further away from the motor vehicle, namely at least up to the rejection distance, before it is no longer classified as relevant. If this vehicle then approaches below the rejection distance again, it is not immediately classified as relevant again, but only when it reaches or falls below the maximum relevance distance, i.e., enters the relevance range. This enables robust and consistent control or regulation of functions or systems based on the objects classified as relevant.

A further aspect of the present invention is an assistance system for a motor vehicle. The assistance system according to the invention has an interface—realized in hardware and/or software—for detecting environment data indicating the positions and relative movements of objects, a processing device, such as a microchip, microprocessor or microcontroller or the like, and a computer-readable data memory coupled thereto. The assistance system according to the invention is set up to carry out the method according to the invention, in particular automatically. For this purpose, a corresponding operating or computer program can be stored in the data memory, which codes or implements the method steps, measures or sequences or corresponding control instructions described in connection with the method according to the invention. This operating or computer program can then be executed or be executable by means of the processing device in order to execute the corresponding method or cause it to be executed. The assistance system according to the invention can, for example, be designed as a control device for a motor vehicle or the like.

A further aspect of the present invention is a motor vehicle which has an environment sensor system for detecting objects in a respective environment of the motor vehicle, i.e., for recording corresponding environment data, and an assistance system according to the invention. The motor vehicle can also have at least one further assistance device which performs or fulfills its function based on the objects classified as relevant by the assistance system according to the invention. The motor vehicle according to the invention can in particular be the motor vehicle mentioned in connection with the assistance system according to the invention or in connection with the method according to the invention or correspond to it.

Further features of the invention may be derived from the claims, the figures and the description of the figures. The features and combinations of features mentioned above in the description as well as the features and combinations of features shown below in the FIGURE description and/or in the FIGURES alone can be used not only in the combination indicated in each case, but also in other combinations or on their own, without departing from the scope of the invention.

### BRIEF DESCRIPTION OF THE DRAWING

FIG. 1 shows a sectional schematic overview of a traffic scene on a road 1.

### DETAILED DESCRIPTION OF THE DRAWING

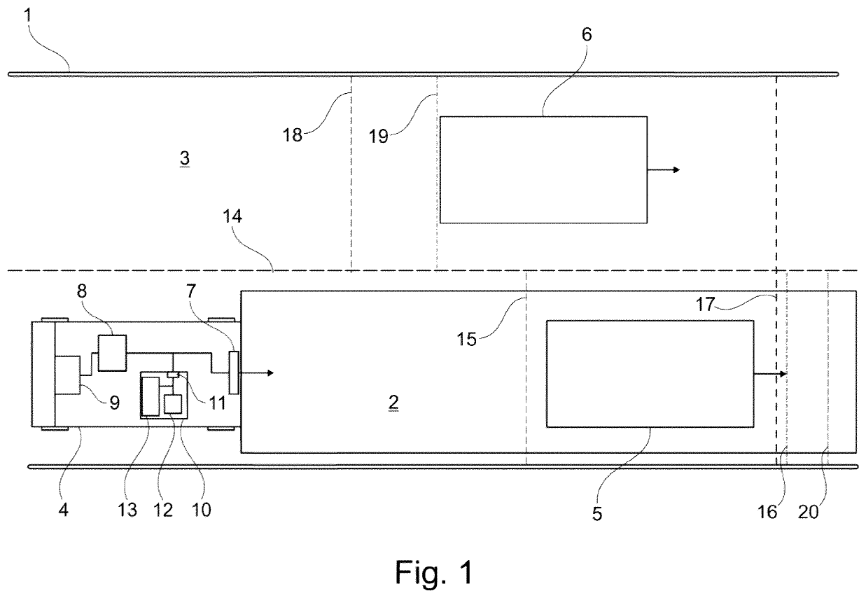

FIG. 1 shows a schematic overview illustrating a method for determining environmental objects relevant for vehicle guidance.

Various assistance functions and systems of vehicles can use as a database or input or take into account which objects present in a respective vehicle environment are actually relevant for vehicle guidance, for example based on their positions and relative movements. FIG. 1 shows a sectional schematic overview of a traffic scene on a road 1. The road 1 comprises a lane 2 and an adjacent lane 3, both of which may be intended for the same direction of travel. On lane 2, a motor vehicle 4 is moving at a certain distance behind a vehicle in front 5. In the same direction of travel as the motor vehicle 4 and the vehicle in front 5, another third-party vehicle, referred to here as secondary vehicle 6, is moving on the adjacent lane 3.

The motor vehicle 4 has an environment sensor system 7 for detecting objects in the respective environment, in particular in the direction of travel ahead. By means of this environment sensor system 7, objects such as the vehicle in front 5 and the secondary vehicle 6 can be detected. Based on the corresponding environment data recorded by the environment sensor system 7, a control device 8 of the motor vehicle 4 can act, for example for longitudinal control of the motor vehicle 4. For this purpose, the control device 8 can, for example, send corresponding control or regulating signals to a vehicle device 9, for example a drive device or the like of the motor vehicle 4. To ensure that the control device 8 can operate effectively, safely and comfortably for the occupants of the motor vehicle 4, only those objects that are actually relevant for driving the motor vehicle 4 should be taken into account. In order to classify the detected objects, here for example the vehicle in front 5 and the secondary vehicle 6, as relevant or not relevant, the motor vehicle 4 has a corresponding assistance system 10. This assistance system 10 comprises an interface 11, schematically indicated here, via which it can record the environment data from the environment sensors 7, as well as a processor 12 and a data memory 13 for processing the environment data.

During operation of the motor vehicle 4, its expected driving tunnel 14 is continuously estimated. A quality of the respective estimation of the driving tunnel 14 is also carried out. This can also be carried out, for example, by the assistance system 10 or another device of the motor vehicle 4.

The relevance of detected objects should not be based exclusively on the current state of motion of the motor vehicle 4 itself. Instead, the relevance here should be determined individually for each object and depending on its relative state of motion in relation to the motor vehicle 4. This makes it possible to determine the—temporal and/or spatial—distance required by the motor vehicle 4 or the control device 8 in order to achieve a steady, i.e., stable, state of the motor vehicle 4 or in the control system behind the respective object. For example, the required spatial distance can be determined directly or the corresponding required time can be determined first and then the distance for the corresponding spatial distance can be determined based on this. A corresponding distance calculation rule and several parameterizations can be specified for this. In particular, at least two different parameterizations or at least two differently parameterized versions of the predefined distance calculation rule can be used to initially calculate two different distances per detected object.

A simple variant of such a distance calculation rule can, for example, be given as s=a+b·MIN(v_{ego}, v_{target})÷c·vᵣₑₗ². The result of the evaluation MIN(v_{ego}, v_{target}) can be the lower of the speeds of the vehicle 4 on the one hand and the respective object under consideration or the target speed of the vehicle 4 in the steady state behind the respective object on the other. The quadratic speed term c·vᵣₑₗ² represents an assumed distance for any braking of the motor vehicle 4 required to reach the steady, stable state. This term can be zero if the speed of the motor vehicle 4 is already less than the speed of the object under consideration.

For example, a first minimum distance 15 is calculated here for the vehicle in front 5 by means of a first parameterization. This first minimum distance 15 defines a minimum relevance range that extends from the motor vehicle 4 in its direction of travel and is minimally required by the motor vehicle 4 in order to reach a steady, i.e., stable, state behind the respective object, in this case behind the vehicle in front 5. A second predefined parameterization is used to calculate a first comfort distance 16 for the vehicle in front 5. This first comfort distance 16 defines an extended relevance range starting from the motor vehicle 4 in its direction of travel, which allows a more comfortable control behavior of the control device 8 and an earlier relevance classification. This means, for example, that a driver of the motor vehicle 4 can be given more confidence in the capabilities of the assistance systems and functions of the motor vehicle 4, i.e., in particular the control device 8 or also the assistance system 10. The first minimum distance 15 is therefore calculated here as a first distance for the vehicle in front 5 and the first comfort distance 16 as a second distance.

In addition, a quality distance 17 is determined as a third distance, which is based on the quality of the estimation of the driving tunnel 14. It is then determined for the advance vehicle 5 whether this quality distance 17 is smaller than the first minimum distance 15 or greater than the first comfort distance 16 or lies between these, i.e., in the interval limited by the first minimum distance 15 and the first comfort distance 16. In the example shown here, the quality distance 17 for the advance vehicle 5 lies between the first minimum distance 15 determined for the advance vehicle 5 and the first comfort distance 16 determined for the advance vehicle 5 and on a side of the advance vehicle 5 facing away from the motor vehicle 4. In other words, the distance of the advance vehicle 5 to the motor vehicle 4 is therefore smaller than the first comfort distance 16 and also smaller than the quality distance 17 but greater than the first minimum distance 15.

It is provided here that the quality distance 17 determines the relevance range if it lies between the respective minimum distance and the respective comfort distance. Since this is the case here for the advance vehicle 5, the quality distance 17 is therefore used as the limit distance or threshold value for a relevance check or relevance classification for the advance vehicle 5. Since the distance between the vehicle in front 5 and the motor vehicle 4 is smaller than the quality distance 17, i.e., the vehicle in front 5 is located within the relevance range extending from the motor vehicle 4 to the quality distance 17, the vehicle in front 5 is classified as relevant for driving the motor vehicle 4. This can be done independently of the driving tunnel 14 or—for example for a more extensive relevance consideration for a specific, downstream driving assistance function—at least or only if it is located in the driving tunnel 14, as is the case here. This means that the preceding vehicle 5 can be taken into account by the control device 8, for example.

If—in contrast to what is shown here for the vehicle in front 5—the quality distance 17 lies outside the interval limited by the first minimum distance 15 and the first comfort distance 16, the interval limit closest to the quality distance 17 is used instead to define the respective object-specific relevance range, i.e., as the threshold value for the relevance check for the respective object, in this case for the vehicle in front 5.

As described for the vehicle in front 5, a corresponding distance calculation and relevance check is also carried out for the secondary vehicle 6. A second minimum distance 18 and a second comfort distance 19 are therefore calculated for the secondary vehicle 6 using the parameters described and taking into account the relative movement of the secondary vehicle 6 with respect to the motor vehicle 4. Here too, it is then determined whether the quality distance 17 is within or outside these limits, i.e., within or outside the interval limited by the second minimum distance 18 and the second comfort distance 16. In the example shown here, the quality distance 17 for the secondary vehicle 6 is greater than the second comfort distance 19. In this case, the quality distance 17 is not used to define the relevance range for the secondary vehicle 6, but the relevance range is restricted to the nearest interval limit, in this case to the second comfort distance 19. Since the distance between the secondary vehicle 6 and the motor vehicle 4 is greater than the second comfort distance 19, the motor vehicle 4 is classified as not relevant for the guidance of the motor vehicle 4. This means, for example, that the control device 8 can perform its function without taking the secondary vehicle 6 into account. The case shown here as an example can occur, for example, if the motor vehicle 4 is moving at a greater speed than the motor vehicle 4 than the vehicle in front 5.

The functionality of the assistance system 10 described here can be used to carry out a distance-dependent relevance assessment of objects as a basis or foundation for various driver assistance systems or assistance functions of the motor vehicle 4. Two extreme cases are described for further explanation. The first extreme case is a stationary object that the motor vehicle 4 is approaching at a certain speed. In order to achieve the steady, i.e., stable, state in the control or vehicle guidance system, the entire speed of the motor vehicle 4 must then be reduced until the motor vehicle 4 comes to a stop behind the stationary object. Such a maneuver can take a relatively long time, for example compared to a less drastic speed adjustment, and can therefore mean a correspondingly large or wide range of relevance for stationary objects or objects moving much slower than the motor vehicle 4. Another extreme case is represented by objects moving at speeds greater than or equal to the speed of the motor vehicle 4 in the same direction of travel as the motor vehicle 4. In this case, a steady, stable state in the control of the motor vehicle 4 is already achieved without further measures, whereby the relevance range can be set or limited to a predetermined or expected distance or a current distance to the respective object or a desired distance or the like set by the driver of the motor vehicle 4.

Once objects have been detected and classified as relevant, such as the vehicle in front 5 in this case, they can move away from the vehicle 4 as it progresses, for example if they accelerate. In this case, a further distance can be determined, beyond which the respective object is no longer classified as relevant, i.e., discarded. This further distance is shown here for the vehicle in front 5 as the first rejection distance 20. This first rejection distance 20 is always greater than the first comfort distance 16. This can be ensured, for example, by specifying a corresponding further parameterization for the distance calculation rule and using it to determine the first rejection distance 20.

It should be noted here that the sizes and distances in FIG. 1, i.e., in particular the positions and distances of the various distances, are not to scale and are shown purely as examples and schematically.

Overall, the described examples show how a longitudinal object selection, especially based on the input data quality, can be realized for the determination of the driving tunnel assignment, i.e., a longitudinal relevance assessment, especially in multimodal embedded systems.

### LIST OF REFERENCE SIGNS

1 road
2 lanes
3 adjacent lane
4 motor vehicle
5 vehicle in front
6 secondary vehicle
7 environment sensors
8 control device
9 vehicle device
10 assistance system
11 interface
12 processor
13 data memory
14 driving tunnel
15 first minimum distance
16 first comfort distance
17 quality distance
18 second minimum distance
19 second comfort distance
20 first rejection distance

1-10. (canceled)

11. A method for a relevance assessment of objects in an environment of a motor vehicle, the method comprising:
recording environment data indicating objects located in a respective environment of the motor vehicle;
determining individual relative movements of the objects relative to the motor vehicle;
determining at least one respective object-specific distance for each detected object as a function of driving parameters predetermined for the motor vehicle, which distance would be required to reach a stable state of the motor vehicle behind the respective object; and
performing a relevance check for each of the defected objects on the basis of the respective at least one object-specific distance, with the respective object being classified as relevant or not relevant for the guidance of the motor vehicle.

12. The method according to claim 11, wherein a maximum permissible jerk of the motor vehicle is also taken into account when determining the respective distance.

13. The method according to claim 11, wherein the relevance is determined for all detected objects, a driving tunnel in which the motor vehicle is likely to move is estimated and only those of the detected objects which have been classified as relevant and are located in the driving tunnel are output as relevant objects for a driving assistance function of the motor vehicle.

14. The method according to claim 11, wherein the determination of the at least one distance comprises:
for the detected objects, in each case a first distance, which results as a minimum distance for safe driving of the motor vehicle, and in each case a greater second distance, which results from a more comfortable vehicle guidance in comparison therewith, and the first distance, the second distance, or a distance lying in between is used for the relevance check.

15. The method according to claim 14, wherein a driving tunnel in which the motor vehicle is likely to move is estimated, a quality of this estimate is determined and, based on this, a third distance is determined, which is smaller in the case of lower quality and larger in the case of higher quality, and
when the third distance is smaller than the first distance, an object is only classified as relevant if its distance from the motor vehicle corresponds at most to the first distance;
when the third distance is greater than the second distance, an object is only classified as relevant if its distance from the motor vehicle corresponds at most to the second distance; and
when the third distance lies between the first distance and the second distance, an object is only classified as relevant if its distance from the motor vehicle corresponds at most to the third distance.

16. The method according to claim 15, wherein the quality is determined as a function of distance and the third distance is used as the distance at which a predetermined quality threshold value is undershot.

17. The method according to claim 11, wherein in the event that a stable state of the motor vehicle is already given with respect to a detected object, a relevance range extended by the motor vehicle in the direction of this object, within which objects are classified as relevant, is limited to a predetermined standard distance or the current distance to the respective object.

18. The method according claim 11, wherein objects classified as relevant are only classified as no longer relevant from a rejection distance which is greater than the distance up to which they would be classified as relevant.

19. An assistance system for a motor vehicle, having an interface for detecting environment data which indicate the positions and relative movement of objects, a processor device and a computer-readable data memory coupled thereto, the assistance system being configured to carrying out a method according to claim 11.

20. A motor vehicle, comprising an environment sensor system for detecting objects in a respective environment of the motor vehicle and an assistance system coupled thereto according to claim 19.
